(19) United States
(12) Patent Application Publication
(10) Pub. No.: US 2015/0259156 A1
(43) Pub. Date: Sep. 17, 2015

(54) D WHEEL TRANSFER DEVICE AND METHOD

(71) Applicants: Melvin W. Henry, Wales, WI (US); Glenn Stockero, New Berlin, WI (US); Darin Danielski, Oconomowoc, WI (US)

(72) Inventors: Melvin W. Henry, Wales, WI (US); Glenn Stockero, New Berlin, WI (US); Darin Danielski, Oconomowoc, WI (US)

(73) Assignee: Facility Functions, Inc., Genesee Depot, WI (US)

(21) Appl. No.: 14/660,445

(22) Filed: Mar. 17, 2015

Related U.S. Application Data
(60) Provisional application No. 61/954,387, filed on Mar. 17, 2014.

(51) Int. Cl. B65G 47/54; B65G 47/82; B65G 37/00

(52) U.S. Cl. CPC B65G 47/54; B65G 37/00; B65G 47/82

(57) ABSTRACT

A transfer device and method for transferring articles moving in a first conveyor path to a second perpendicular path is disclosed. The transfer device includes a wheel transfer vane assembly having a wheel assembly. Wheels used in the wheel assembly have a circumferential surface with a generally “D” configuration. The wheels have a first, generally flat side and a second, curved side.

### RELATED APPLICATIONS

This application claims the benefit of co-pending U.S. Provisional Patent Application Ser. No. 61/954,387, filed on 17 Mar. 2014, and titled “D Wheel Transfer Device”.

### BACKGROUND OF THE INVENTION

The present invention relates in general to conveyor systems, particularly systems having a device to turn a conveyed object from a first conveyor path to a second conveyor path wherein the second conveyor path is perpendicular to the first conveyor path. Devices of this type are often needed when articles travelling on a conveyor are to be sorted. The articles may be sorted automatically or by hand, and when an article is recognized, the article is moved at a 90 degree angle to a perpendicular conveyor that transports the article to a different location, for example to be stored. Known devices used to transfer an article to a second conveyor or other perpendicular path typically elevate or lift the article through the use of pop-up rollers, cantilevered plates or the like. The present transfer device is unlike these known redirection devices which typically require the redirection device to lift itself and the product to an elevated position to effect product redirection. In contrast, no lifting of the present device is required to properly move product from rollers moving in a first conveyor direction to a second, perpendicular conveyor direction.

### SUMMARY OF THE INVENTION

It is therefore a feature of the present invention to provide a transfer subassembly that easily redirects conveyed articles, is economical to manufacture and is able to turn articles without elevating the device above the conveyor surface. The present transfer device is unlike known lifting redirection devices since no lifting of the present device is required to properly move product from rollers moving in a first conveyor direction to a second, perpendicular conveyor direction. The invention is directed to use in conveyor systems such as motorized driven roller conveyor systems, particularly, conveyor systems which direct transported articles in an initial direction and then utilize a transfer device to move the articles in a second, perpendicular direction. Specifically, the present invention is an electro/mechanical transfer device having consecutive D-wheels. The driven transfer device moves articles travelling in a first conveyor direction to a second, perpendicular direction. The transfer device may be used to move articles from one conveyor system to another, perpendicularly situated system, or to off-load product in a perpendicular travel pattern, into a bin or other collection device.

A transfer device according to the present invention preferably includes transfer bed sub-assembly having at least one wheel transfer vane assembly. The wheel transfer vane assembly includes at least one wheel assembly. Specifically, the wheels used in the present device include a circumferential surface having a generally “D” configuration. Particularly, the wheels have a first, generally flat side and a second, curved side. D-wheels for use with the present transfer device may be molded of plastic or other suitable material, and may further include a urethane over-molded wrap to aid in product friction. D-wheels used with the present invention are preferably arranged consecutively into rows or series of rows which may be cog belt driven, gear driven, or chain driven. One embodiment includes a split D-wheel design for use with a cog belt drive system or split sprocketed chain drive. The split. D-wheel design allows for economies and design tolerances, as well as less component wear.

Preferably, consecutive D-wheels are mounted together to create a row and are attached in series, in vane assemblies, between conveyor rollers. The arrangement of vane assemblies effects proper handling of different width products moving along the conveyor path. The series of rows of D-wheels are driven with a common shaft to rotate the wheels when required during transfer.

The D-wheels used with the present transfer device include a circumferential surface having a generally “D” configuration. When the first, flat side of the D-wheel is adjacent the transferring article surface, the article is allowed movement straight through in a first conveyor direction. When the D-wheel is rotated and the opposite, curved side is adjacent the article surface, the article is redirected and propelled in a second conveyor direction perpendicular to the first conveyor direction.

Rotation of the D-wheels from a first. Lo a second position occurs when, for example, an article to be redirected is detected by an optical sensor, or other suitable detection mechanism. When an article to be redirected is detected, a motor drive may be engaged to begin rotation of the D-wheels in the transfer vane assemblies. As the D-wheels rotate, the article is subtly moved away from the conveyor and onto the curved side of the D-wheels. Continued rotation of the D-wheels moves the article in a second, perpendicular conveyor direction.

The arrangement of the present transfer device creates near constant contact points with an article during transfer. Further, the transfer device is not required run continually, but rather, is adapted to run only when programmed to do so and when an article to be transferred is present. The ability of the transfer device to run only when required adds flexibility in a conveyor system such that articles may or may not be redirected during continual use.

Further, the present transfer device is modular and may be easily mounted to any line shaft or MDR frame. In addition, the D-wheels of the transfer device are able to be quickly disconnected for replacement or inspection. The transfer device further includes plug and play control, and flexibility in the number of transfer vane assemblies mountable to conveyor systems to therefore make the device easily adaptable to various product widths and user settings.

### BRIEF DESCRIPTION OF THE DRAWINGS

FIG. 1 is a perspective view of a conveyor system including a perpendicular track and including a transfer system according to the present invention.

FIG. 2 is a perspective view of a D-wheel transfer bed sub-assembly for use with the system illustrated in FIG. 1 and showing the D-wheels with their flattened sides adjacent a product path.

FIG. 3 is an exploded view of the D-wheel transfer bed sub-assembly illustrated in FIG. 2.

FIG. 4 is a bottom view of the D-wheel transfer bed sub-assembly illustrated in FIGS. 2 and 3.

FIG. 5 is an end section view of the assembly illustrated in FIG. 4, and taken along lines 5-5 of FIG. 2.

FIG. 6 is a side section view of the assembly illustrated in FIG. 2, and taken along lines 6-6 thereof.

FIG. 7 is a perspective view of D-wheel transfer vane assembly showing the D-wheels in a first position, with the flat sides of the D-wheels adjacent a product path.

FIG. 8 is an exploded view of the transfer vane assembly illustrated in FIG. 7 and showing a split cog belt driven arrangement.

FIG. 9 is a perspective view of a D-wheel transfer vane assembly, similar to that of FIG. 7, but showing the D-wheels in a second position, with the curved sides of the D-wheels adjacent a product path.

FIG. 10 is an exploded view of a D wheel for use with the assembly illustrated in FIGS. 7-9.

FIG. 11 is a perspective view of a mold for use in the first step of manufacturing the D wheel illustrated in FIG. 10.

FIG. 12 is a front view of a D-wheel after molding in the first mold shown in FIG. 11.

FIG. 13 is a perspective view, similar to that of FIG. 11, but showing a second mold for use in the second, over-molding step of manufacturing the D wheel illustrated in FIG. 10.

FIG. 14 is a perspective view of a D-wheel after the over-molding step.

FIG. 15 is a perspective view, similar to that of FIG. 1, but showing product moving in a first conveyor direction.

FIG. 16 is a view similar to that of FIG. 15, but showing the product in place over the transfer system and ready to be moved in a second conveyor direction.

FIG. 17 is a view similar to that of FIG. 5, but showing a fragmentary view of a conveyor system and an object to be transported with the flattened side of the D-wheels adjacent the object.

FIG. 18 is a view similar to that of FIGS. 15 and 17, but showing the D-wheels rotating and the product moving in a second conveyor direction away from the transfer assembly.

FIG. 19 is a view similar to that of FIG. 17 but showing the D-wheels rotating such that the rounded sides of the D-wheels are adjacent the object and the object is moved in a second conveyor direction and away from the transfer assembly.

FIG. 20 is a view similar to that of FIGS. 16, 18, and 19 but showing the product moving in a second conveyor direction.

FIG. 21 is a perspective view of another embodiment D-wheel transfer bed sub-assembly having a sprocket and chain drive, and showing the D-wheels with their flattened sides adjacent a product path.

FIG. 22 is an exploded view of the D-wheel transfer bed sub-assembly illustrated in FIG. 21.

FIG. 23 is a perspective view of a D-wheel transfer vane assembly for use with the transfer bed sub-assembly illustrated in FIG. 21 and showing the D-wheels in a first position, with the flat sides of the D-wheels adjacent a product path.

FIG. 24 is a perspective view of a D-wheel transfer vane assembly, similar to that of FIG. 23, but showing the D-wheels in a second position, with the curved sides of the D-wheels adjacent a product path.

FIG. 25 is an exploded view of the transfer vane assembly illustrated in FIG. 23 and showing a split, sprocket and chain drive arrangement.

FIG. 26 is an exploded view of a D-wheel for use with the transfer bed sub-assembly illustrated in FIGS. 21-25.

FIG. 27 is an end section view of the transfer vane assembly illustrated in FIG. 21, and taken along lines 27-27 thereof.

FIG. 28 is a side section view of the assembly illustrated in FIG. 21, and taken along lines 28-28 thereof.

FIG. 29 is a perspective view of another embodiment D-wheel transfer vane assembly for use with the transfer bed sub-assembly illustrated in FIG. 30 and showing a single D-wheel gear driven assembly.

FIG. 30 is an exploded view of the transfer vane assembly illustrated in FIG. 29 and showing a gear drive arrangement.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

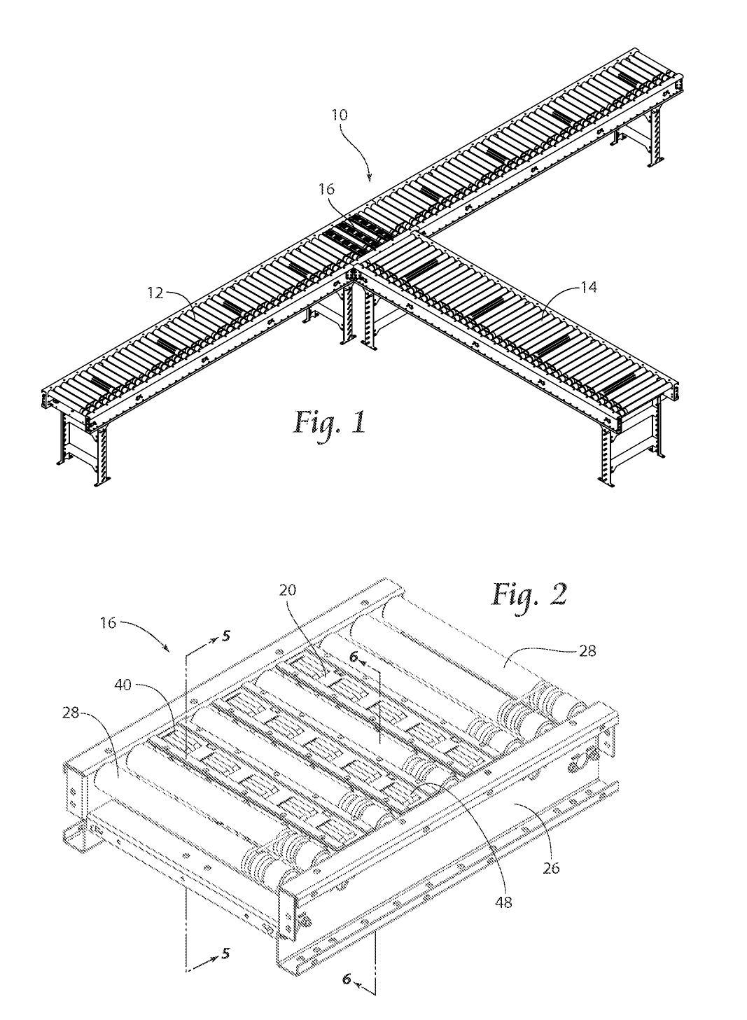

Referring to FIG. 1, a conveyor system 10 for use with the present invention may be seen. As shown, the conveyor system 10 includes a first conveyor 12 adapted to move in a first conveyor direction, and a second, perpendicular conveyor 14. The system 10 further includes a transfer device 16 for directing articles 18 (not seen in this view) moving on the first conveyor 12 in a first conveyor direction to the second, perpendicular conveyor 14. Although the transfer device 16 is shown herein as moving articles 18 from a first conveyor 12 to a second, perpendicularly situated conveyor 14, it is to be understood that a transfer assembly 16 according to the present invention may also be used to transfer articles 18 moving on a first conveyor 12 in a first conveyor direction to a perpendicular travel pattern to off-load, into a bin or other collection device (not shown).

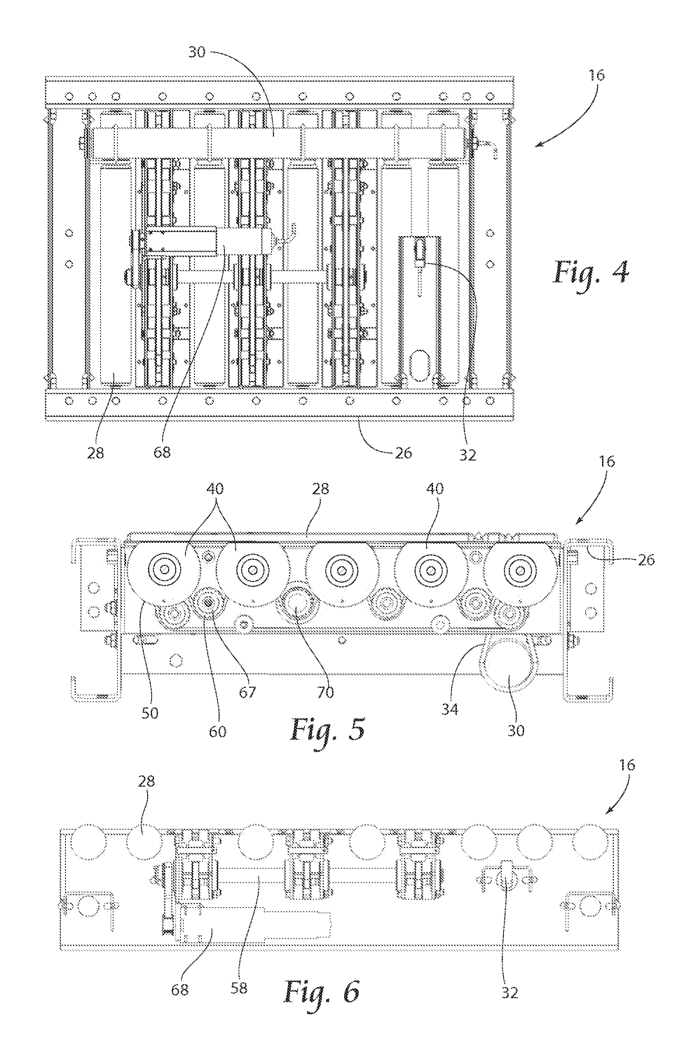

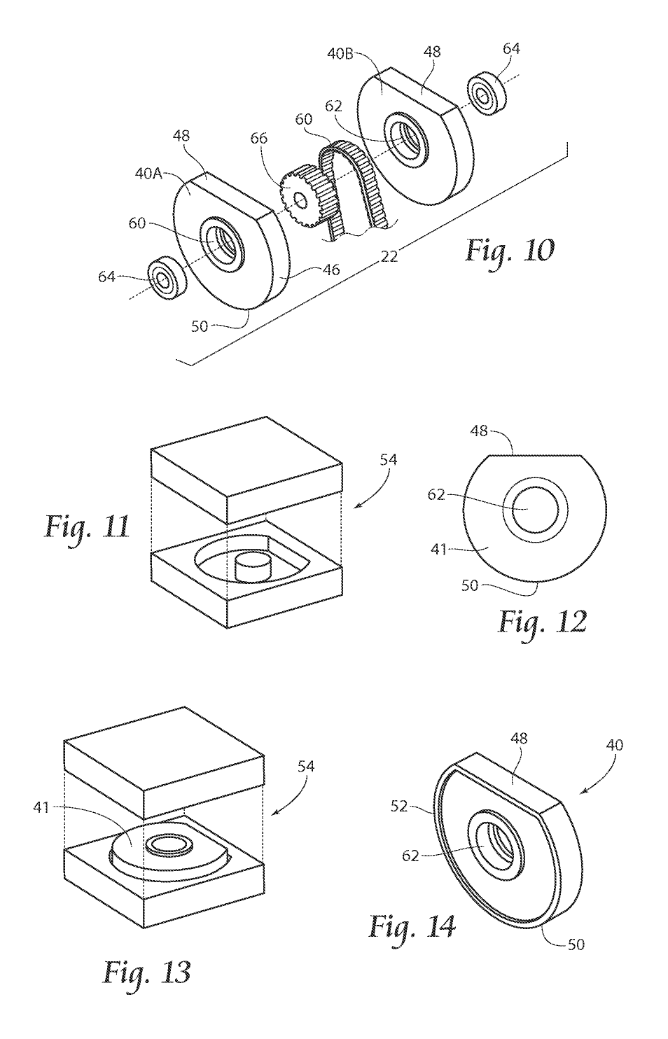

With particular attention now to FIGS. 2, 3 and 8, a transfer device 16 according to the present invention may be seen. As shown, the transfer device 16 preferably includes at least one wheel transfer vane assembly 20 having at least one wheel drive assembly 24. As shown a frame 26 supports a plurality of conveyor rollers 28, a conveyor drive roller 30, and at least one wheel transfer vane assembly 20. A sensor 32 (see FIGS. 4 and 6) may further be provided, as will be discussed. As seen, the conveyor rollers 28 are driven by a conveyor drive roller 30 and belt 34 configuration, although other arrangements may be used. The transfer vane assembly 20 includes a housing 36 (see FIG. 8) to support the wheel drive assembly 24. The wheel drive assembly 24 includes wheel assemblies 22 having D-wheels 40 and axles 42, and a motor drive assembly 44. With specific attention to FIGS. 8 and 10, it may be seen that D-wheels 40 for use in the present transfer device 16 include a circumferential surface 46 having a generally “D” configuration. Particularly, the D-wheels 40 have a first, generally flat side 48 and a second, curved side 50.

As is shown in FIGS. 11-14, D-wheels 40 for use with the present transfer device 16 may be molded plastic or other suitable material, and may include an over mold 52, such as a urethane wrap to aid in product friction (see FIG. 14). As is shown, a process of manufacturing a D-wheel 40 for use with the invention may include using a first mold 54 to form a D-wheel core 41. The D-wheel core 41 is then inserted into a second mold 56 wherein an outer over mold 52 is applied to form a D-wheel 40 to be used in a wheel assembly 22. The over mold 52 may preferably be of any suitable material to aid in product friction, such as a urethane wrap.

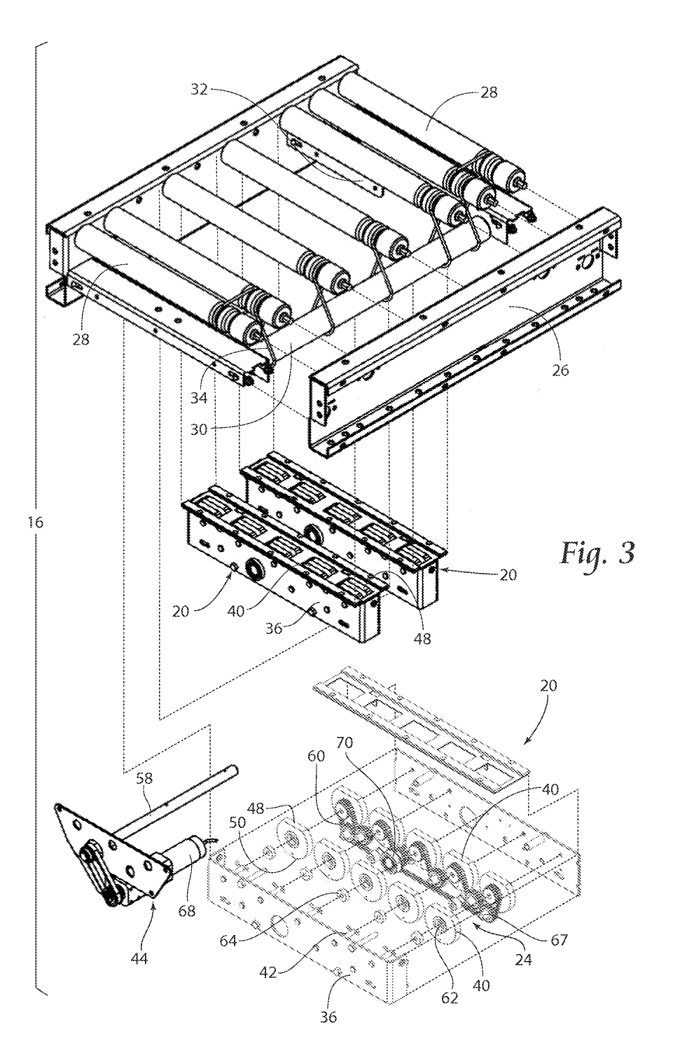

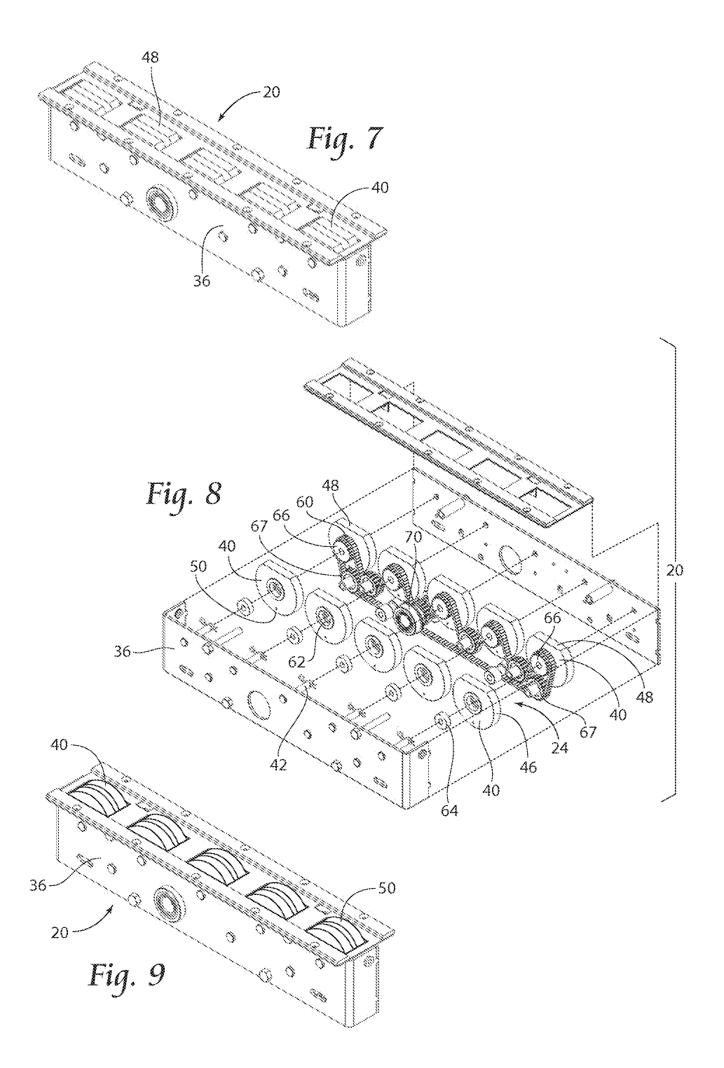

As illustrated particularly in the views of FIGS. 3 and 7-9, the D-wheels 40 are preferably arranged consecutively into rows or series of rows when mounted together and are attached in series, in the vane assemblies 20. The vane assemblies 20 may be cog belt driven, gear driven, or chain driven between the conveyor rollers 28 to effect proper handling of articles 18 having varying sizes moving along a conveyor 12 path. The vane assemblies 20 are driven with a common shaft 58 to rotate the D-wheels 40 as required during article 18 transfer. The views of FIGS. 7-10 illustrate vane assemblies 20 wherein the wheel drive assembly 24 is cog belt 60 driven, as will be discussed.

As is shown in particularly in FIGS. 3, 8, and 10, the wheel assemblies 22 may include D-wheels 40 having a split D-wheel design. In a split wheel design the D-wheels include a first D-wheel 40A and a second D-wheel 40B, each of the D-wheels 40A, 40B having a center aperture 62 which is adapted to be supported on axles 42 mounted on the housing 36. Bushings 64 may also be provided for ease in rotation. As may be viewed particularly in FIG. 10, the split D-wheels 40A, 40B used in the wheel drive assembly 24 of this embodiment are driven by a gear 66 and cog belt 60 arrangement. A drive shaft 58, actuated by a drive motor 68, rotates the drive gear 70 (see FIGS. 3 and 8) when rotation of the split D-wheels 40A, 40B is desired. As is shown in FIG. 8, the cog belt 60 engages the gears 66 and idler gears 67 during rotation. The split D-wheel design allows for economies and design tolerances, as well as less component wear.

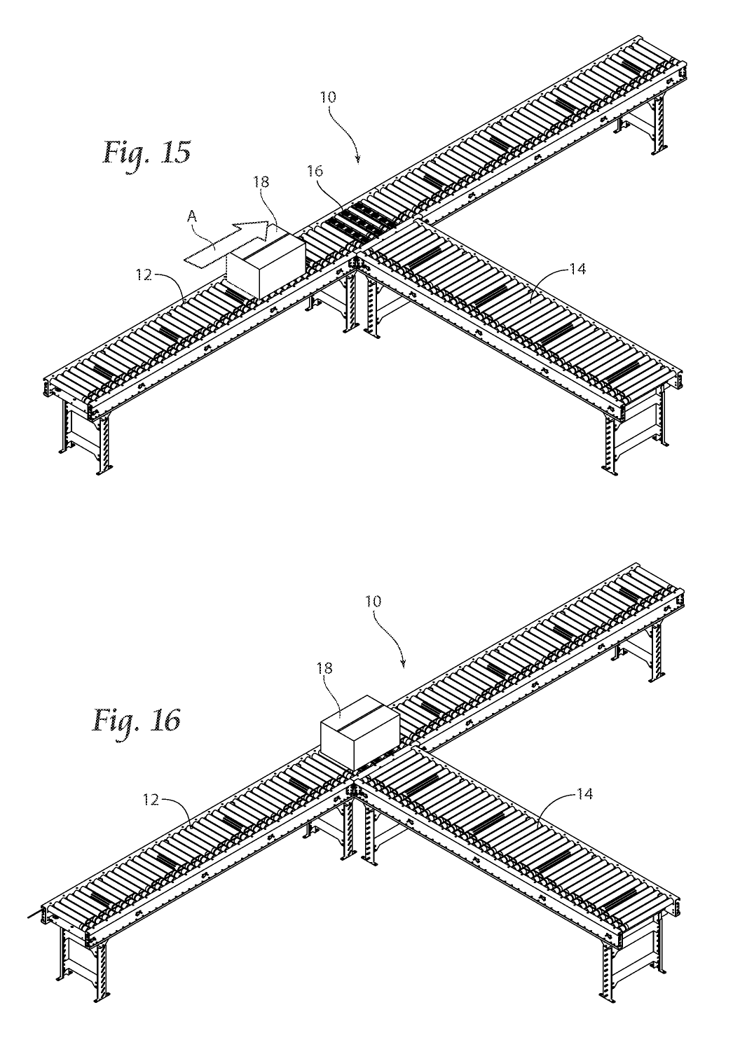

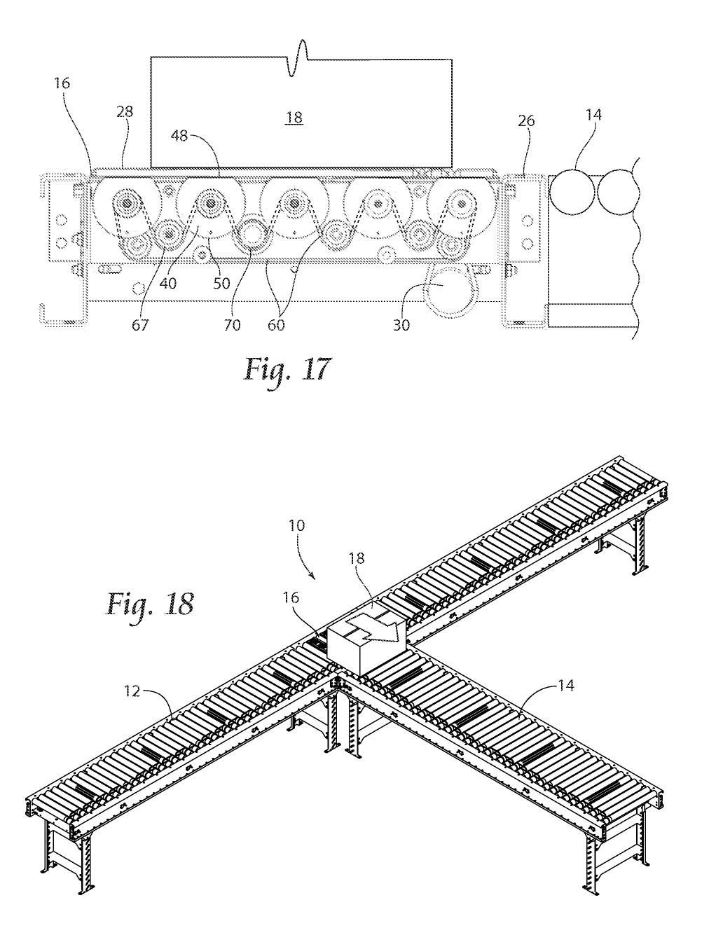

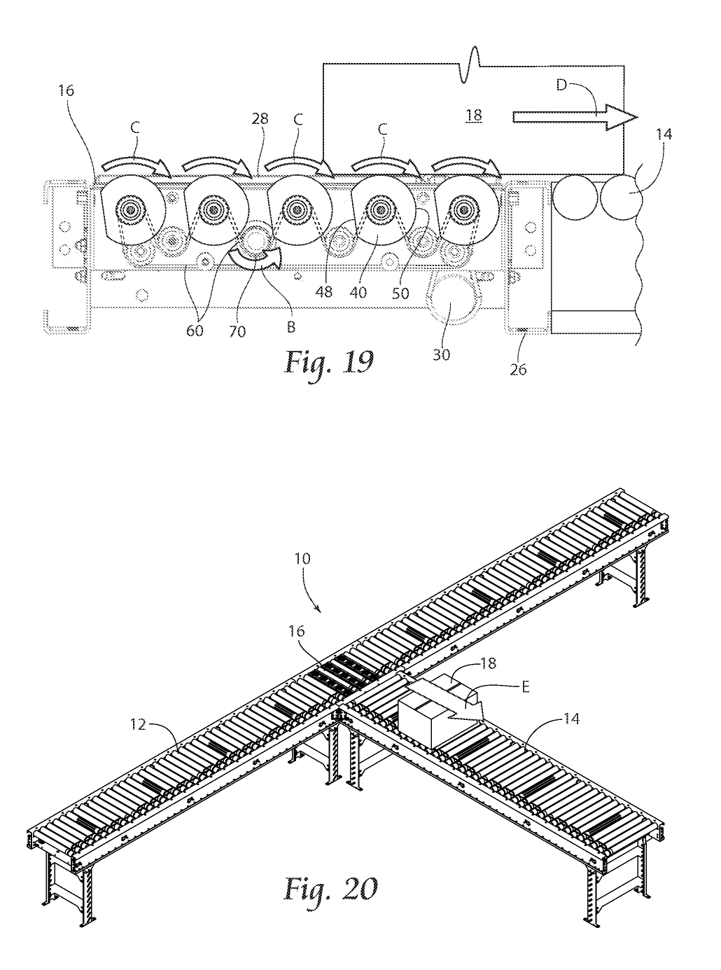

In use, and as seen in the views of FIGS. 15-20, an article 18 is moved on a first conveyor 12 in the direction of arrow A. As long as the article 18 is required to continue in the direction of arrow A, the transfer device 16 remains in an inactivated state, with the D-wheels 40 rotated such that the flat sides 48 are adjacent the conveyed articles 18, as is seen in FIG. 17. When the sensor 32 detects an article 18 which requires redirection, the transfer device 16 is activated. A sensor 32 for use with the present invention may be an optical sensor, or other suitable detection mechanism, that reads or detects a predetermined article 18 quality. Such qualities may include, but are not limited to weight, size, bar codes, or the like. When an article 18 requiring redirection is adjacent the transfer device 16, as is shown in FIG. 19, a drive motor 68 may be engaged to power the wheel drive assembly 24 and begin rotation of the D-wheels 40 in the transfer vane assemblies 20. Preferably, the transfer device 16 utilizes low voltage direct current motors; however, any suitable drives means may be utilized without departing from the invention. With further attention to FIG. 19, the drive shaft 58, actuated by the drive motor 68, rotates the drive gear 70 in the direction of arrow B and the D-wheels 40 rotate in the direction of arrows C. As the D-wheels 40 rotate, the second, curved sides 50 of the wheels 40 subtly elevate the article 18 away from the first conveyor 12 and onto the curved sides 50 of the D-wheels 40 thereby urging the article 18 in a direction perpendicular to the original path, and in the direction of arrow D. The drive motor 68 may accelerate or decelerate the article 18, as required. Continued rotation of the D-wheels 40 moves the article 18 to a second, perpendicular conveyor in the direction of arrow E (see FIG. 20). As previously mentioned, while the transfer device 16 is illustrated as being used to move articles 18 from a first conveyor 12 to another, perpendicularly situated conveyor 14, it is within the scope of the present invention to use the transfer device 16 to off-load articles 18 in any perpendicular travel pattern, such as into a bin or other collection device, by way of non-limiting examples.

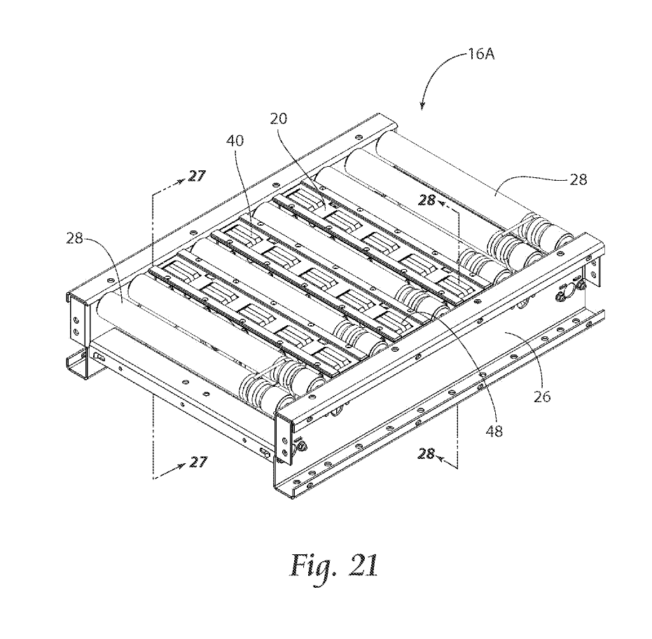

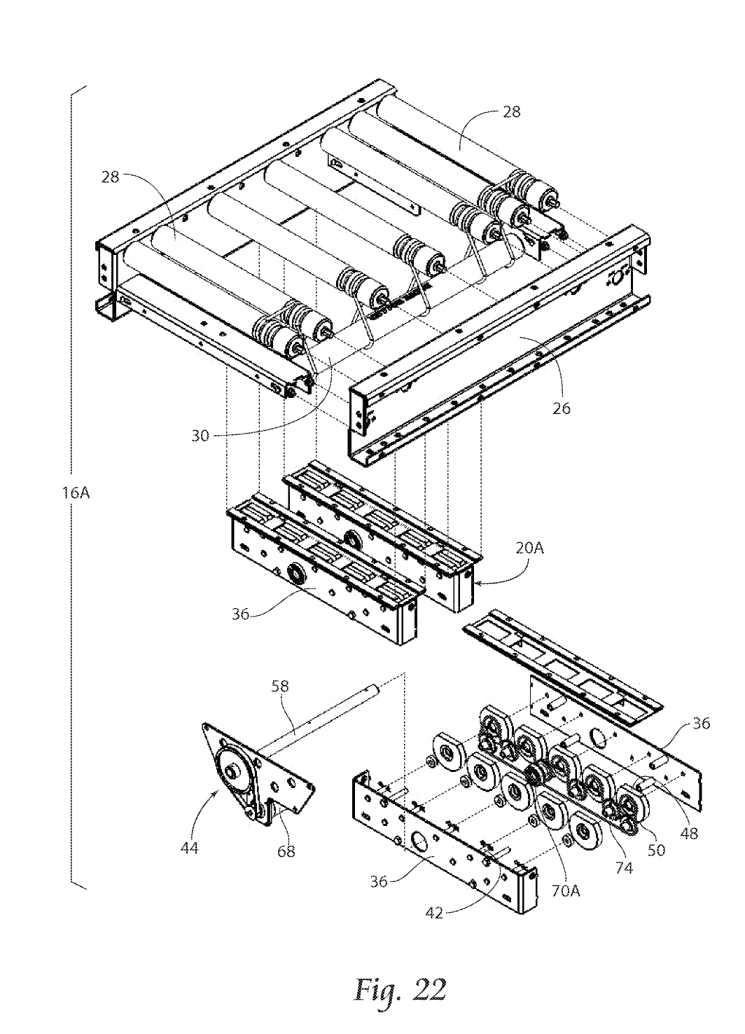

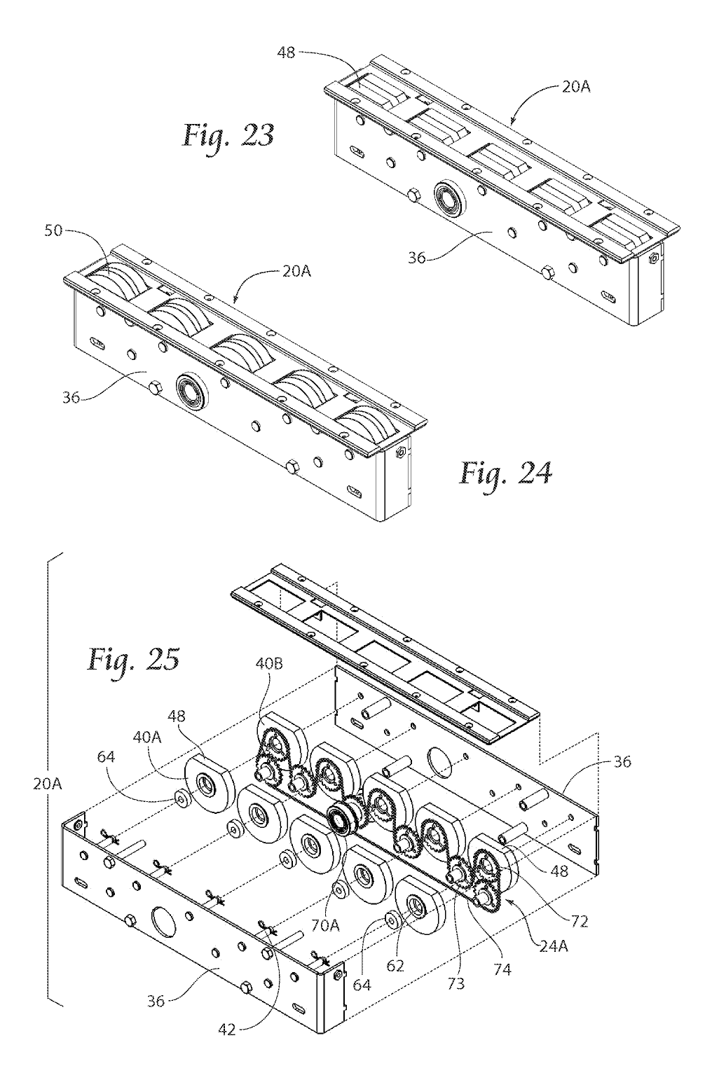

With attention now to FIGS. 21-28, another embodiment of the present invention may be seen, in which the transfer device 16A utilizes a sprocket 72 and chain 74 drive. As in the previously described embodiment, the transfer device 16A of these views is adapted for use with a conveyor system 10 having a first conveyor 12 adapted to move in a first conveyor direction, and a second, perpendicular conveyor 14 (see FIG. 1). Similar to the previously described embodiment, the transfer device 16A in these views includes at least one wheel transfer vane assembly 20A which includes at least one wheel drive assembly 24A. As in the previous embodiment, the transfer device 16A includes a frame 26 which supports a plurality of conveyor rollers 28, a conveyor drive roller 30, and the transfer vane assembly 20A. The transfer vane assembly 20A includes a housing 36 to support the wheel drive assembly 24A including D-wheels 40 and their axles 42. As in the previous embodiment, the D-wheels 40 for use in the present transfer device 16A include a circumferential surface 46 having a generally “D” configuration having a first, generally flat side 48 and a second, curved side 50, and may be manufactured in a manner similar to that described with regard to FIGS. 11-14.

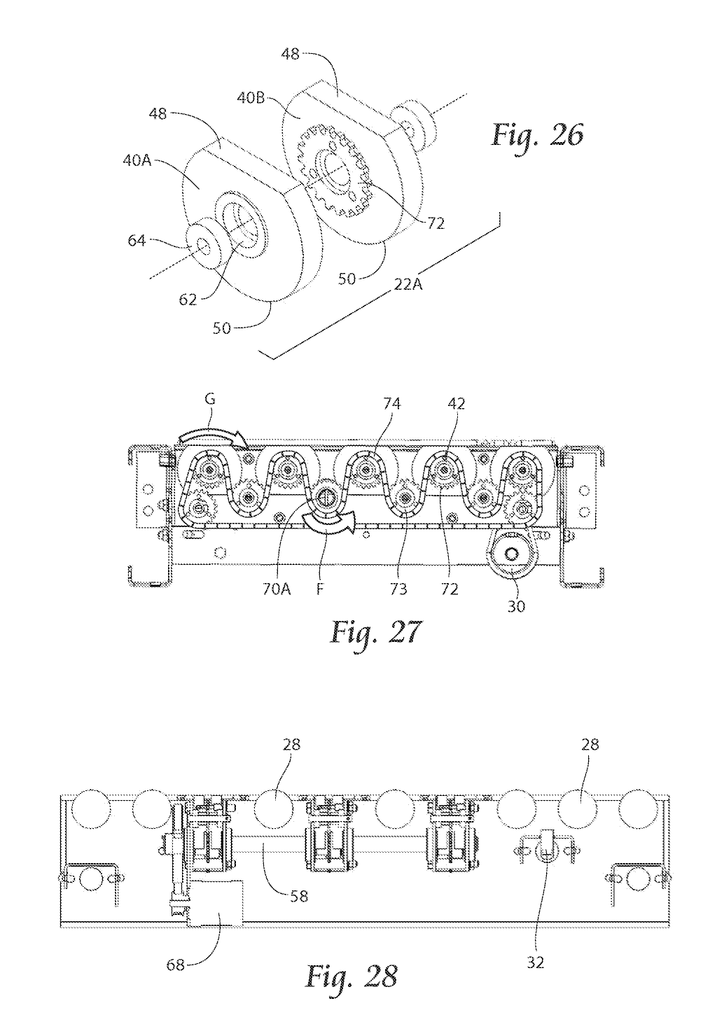

With further attention to FIGS. 21-28, and particularly to FIG. 26, the wheel assemblies 22A in these views include D-wheels 40 having a split D-wheel design. The split D-wheels include a first D-wheel 40A and a second D-wheel 40B, each of the D-wheels 40A, 40B having a center aperture 62 which is adapted to be supported on axles 42 mounted on the vane housing 36. Bushings 64 may also be provided for ease in rotation. As is further seen in FIG. 26, the wheel drive assembly 24A having the split D-wheels 40A, 40B of this embodiment is driven by a sprocket 72 and chain 74 arrangement. A drive shaft 58, actuated by a drive motor 68, rotates a drive sprocket 70A when rotation of the D-wheels 40 is desired. As is shown in FIG. 27, the chain 74 engages the sprockets 72 and idler sprockets 73 during rotation. The split D-wheel design allows for economies and design tolerances, as well as less component wear.

The alternative sprocket 72 and chain 74 drive arrangement illustrated in FIGS. 21-28 operates in a manner similar to that discussed with regard to FIGS. 15-20, whereby an article 18 is moved on a first conveyor 12 in the direction of arrow A with the transfer device 16A remaining in an inactivated state until the sensor 32 detects an article 18 which requires redirection. When such an article 18 is detected, the transfer device 16A is activated. When the transfer device 16A illustrated in FIGS. 21-28 is activated, a drive motor 68 may be engaged to begin rotation of the D-wheels 40 in the transfer vane assemblies 20A. Preferably, the transfer device 16A utilizes low voltage direct current motors; however, any suitable drives means may be utilized without departing from the invention. As seen in FIG. 27, the drive shaft 58, actuated by the drive motor 68, rotates a drive sprocket 70A in the direction of arrow F and the D-wheels 40 in the direction of arrows G. As previously described, the D-wheels 40 rotate, the second, curved sides 50 of the wheels 40 subtly elevate the article 18 away from the first conveyor 12 and onto the curved sides 50 of the D-wheels 40 thereby urging the article 18 in a direction perpendicular to the original path.

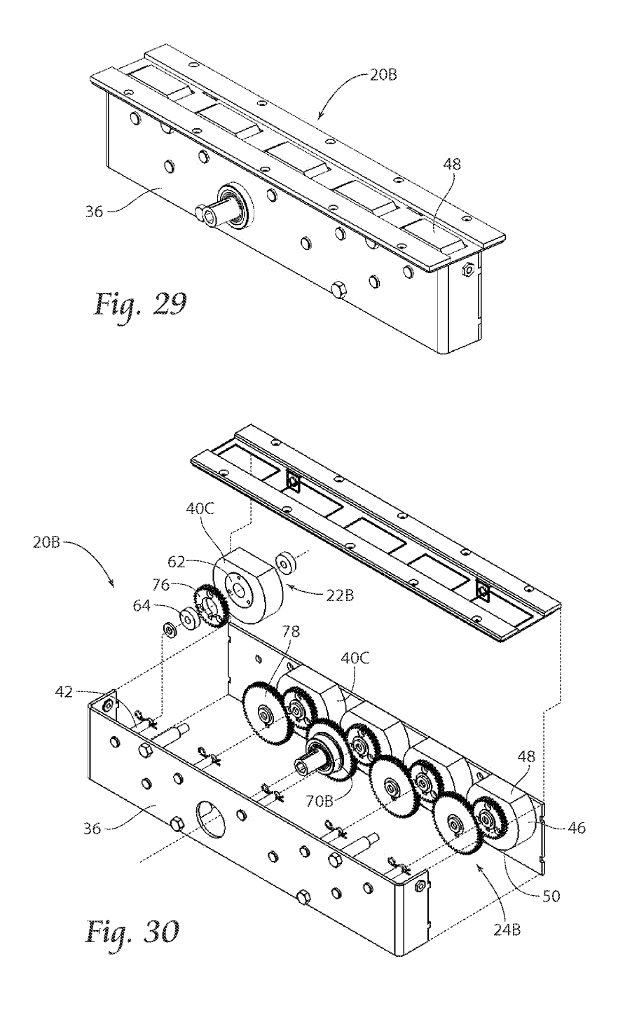

With attention now to FIGS. 29-30, another embodiment of the present invention which utilizes a gear driven transfer vane assembly 20B, may be seen. As in the previously described embodiments, a transfer device 16 having a gear driven transfer vane assembly 20B may be used with a conveyor system 10, as previously discussed. The system 10 selectively moves an article 18 from a first direction to a perpendicular direction. The wheel transfer vane assembly 20B of these views includes at least one wheel drive assembly 24B and a housing 36 to support the wheel assemblies 22B, including D-wheels 40C, their axles 42, and the wheel drive assembly 24B. As in the previous embodiment, the D-wheels 40C for use in the vane assembly 20B shown include a circumferential surface 46 having a generally “D” configuration having a first, generally flat side 48 and a second, curved side 50. The D-wheels 40C used in these views are of a single piece rather than the split wheel design of the previous embodiments. The D-wheels 40C illustrated in FIGS. 29 and 30 include a center aperture 62 which is adapted to be supported on axles 42 mounted on the vane housing 36. Bushings 64 may also be provided for ease in rotation. As seen particularly in FIG. 30, wheel drive assembly 24B drives the D-wheels 40C using a gear to gear arrangement. As in the previous embodiment, a drive shaft 58, actuated by a drive motor 68 (not seen in these views), is used to rotate a drive mechanism, seen as a drive gear 70B in this view. As is shown in FIG. 30, the wheel drive assembly 24B includes wheel gears 76 which engage corresponding vane gears 78 during rotation.

The alternative wheel gear 76 and vane gear 78 drive arrangement illustrated in FIG. 30 operates in a manner similar to that discussed with regard to the previous embodiments, whereby an article 18 is moved on a first conveyor 12 in a first direction with the vane assembly 20B remaining in an inactivated state until the sensor 32 detects an article 18 which requires redirection. When such an article 18 is detected, a drive motor 68 (not seen is this view) may be engaged to begin rotation of the D-wheels 40C in the transfer vane assemblies 20B. The drive shaft 58, rotates a drive gear 70B and the wheel gears 76, vane gears 78 and D-wheels 40C begin rotating such that the second, curved sides 50 of the wheels 40C subtly elevate the article 18 away from the first conveyor 12 and onto the curved sides 50 of the D-wheels 40C thereby urging the article 18 in a direction perpendicular to the original path.

The arrangement of the present transfer device 16, 16A and vane assemblies 20, 20A, 20B creates near constant contact points with an article 18 during transfer. Further, the transfer device 16, 16A is not required run continually, but rather, is adapted to run only when programmed to do so and when an article needing redirection is present. This feature adds flexibility in a conveyor system 10 such that articles 18 may or may not be redirected during continual use.

The transfer devices 16, 16A described herein are modular and may be easily mounted to any line shaft or MDR frame. In addition, the D-wheels 40, 40A, 40B, 40C of the present invention are able to be quickly disconnected for replacement or inspection. The present invention further includes plug and play control, and flexibility in the number of transfer vane assemblies 20, 20A, 20B mountable to conveyor systems 10 to therefore make the device easily adaptable to various article 18 widths and user settings.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I/we claim:

1. A conveyor system for moving articles including:
a first conveyor adapted to move in a first conveyor direction,
a second conveyor adapted to move in a second conveyor direction, wherein said second conveyor direction is perpendicular to said first conveyor direction, and
a transfer device for directing articles moving on said first conveyor in a first conveyor direction to said second conveyor direction.

2. The conveyor system of claim 1 wherein said transfer device includes at least one transfer vane assembly.

3. The conveyor system of claim 2 wherein said at least one transfer vane assembly includes a housing and at least one wheel drive assembly.

4. The conveyor system of claim 3 wherein said transfer device further includes a plurality of conveyor rollers, a conveyor drive roller, and a drive assembly.

5. The conveyor system of claim 4 wherein said transfer device further includes a sensor.

6. The conveyor system of claim 5 wherein said at least one wheel drive assembly includes at least one wheel assembly, said wheel assembly having at least one wheel supported on an axle, wherein said at least one wheel includes a circumferential surface having a first, generally flat side and a second, curved side.

7. The conveyor system of claim 6 wherein said at least one wheel drive assembly includes at least one drive gear and at least one cog belt arranged to engage said at least one drive gear, said drive gear being selectively actuated by a drive shaft and drive motor.

8. The conveyor system of claim 7 wherein said at least one wheel includes a gear arranged for engagement by said cog belt.

9. The conveyor system of claim 6 wherein said wheel drive assembly includes at least one drive sprocket and a chain arranged to engage said at least one drive sprocket, said drive sprocket being selectively actuated by a drive shaft and drive motor.

10. The conveyor system of claim 6 wherein said wheel drive assembly includes at least one drive gear, at least one wheel gear, and at least one vane gear, said drive gear being selectively actuated by a drive shaft and drive motor.

11. A transfer device for directing articles moving in a first conveyor direction to a second, perpendicular direction, said transfer device including:
a frame; and
at least one transfer vane assembly supported on said frame and including a housing and at least one wheel drive assembly.

12. The transfer device of claim 11 further including a plurality of conveyor rollers, a conveyor drive roller, and a drive assembly.

13. The transfer device of claim 12 further including a sensor.

14. The transfer device of claim 13 wherein said at least one wheel drive assembly includes at least one wheel supported on an axle, wherein said at least one wheel includes a circumferential surface having a first, generally flat side and a second, curved side.

15. The transfer device of claim 14 wherein said at least one wheel drive assembly includes at least one drive gear and cog belt arranged to engage said at least one drive gear, said drive gear being selectively actuated by a drive shaft and drive motor.

16. The transfer device of claim 15 wherein said at least one wheel includes a gear arranged for engagement by said cog belt.

17. The transfer device of claim 14 wherein said at least one wheel drive assembly includes at least one drive sprocket and a chain arranged to engage said at least one drive sprocket, said drive sprocket being selectively actuated by a drive shaft and drive motor.

18. The conveyor system of claim 14 wherein said at least one wheel drive assembly includes at least one drive gear, at least one wheel gear, and at least one vane gear, said drive gear being selectively actuated by a drive shaft and drive motor.

19. A method for directing articles moving in a first conveyor direction to a second, perpendicular direction, said method including the steps of:
providing a transfer device, said transfer device including at least one transfer vane assembly having a sensor and at least one wheel drive assembly, said at least one wheel drive assembly including at least one wheel supported on an axle, wherein said at least one wheel includes a circumferential surface having a first, generally flat side and a second, curved side;
moving an article in a first conveyor direction toward said transfer device;
positioning said first, generally flat side of said at least one wheel adjacent to said article;
moving said article in a first conveyor direction and over said transfer device;
using said sensor to detect and identify said article as requiring transfer;
actuating said at least one wheel drive assembly;
rotating said at least one wheel to position said second, curved side adjacent to said article; and
moving said article in a direction perpendicular to said first conveyor direction.
